(19) United States
(12) Patent Application Publication
(10) Pub. No.: US 2008/0213734 A1
(43) Pub. Date: Sep. 4, 2008

(54) Method for Decoding Pictographic Signs Present on Ancient Artifacts

(76) Inventor: Steve George Guide, Sofia (BG)

Correspondence Address: Todor Yotov, 65 Milin Kamak Str., Sofia, 1164, BG

(21) Appl. No.: 11/692,960

(22) Filed: Mar. 29, 2007

Related U.S. Application Data
(60) Provisional application No. 60/744,132, filed on Apr. 2, 2006.

(51) Int. Cl. G09B 19/00

(52) U.S. Cl. 434/156

(57) ABSTRACT

The invention is a method for transcribing and decoding/reading pictographic characters found on ancient artifacts, dated either prior, during or after the time of the beginnings of Dynastic Ancient Egypt (circa 3100 BC), in such a way, so that they may be presented in schematic drawings (sets of pictographic signs) for which analogues are found in Hieroglyphic Inscriptions, following the stylized version of the pictographic script from the pyramid texts of Ancient Egypt, independent of the calligraphic styles applied. Thus transcribed in the form and shape of Egyptian Hieroglyphs, these characters are then translated into modern languages, using the scientifically accepted systems for reading the Egyptian hieroglyphic script.

### CROSS REFERENCE TO RELATED APPLICATION

This application claims the benefit and priority of U.S. provisional application Ser. No. 60/744,132, filed Apr. 2, 2006 the disclosure of which is incorporated herein by reference.

### BACKGROUND OF INVENTION

1. Field of Invention

This invention relates generally to translation methods and, more particularly, to methods of decoding sets of signs inscribed on ancient artifacts.

2. Background Art

Researchers and practitioners in the fields of archaeology, linguistics and related domains regularly encounter artifacts and documents that no modern person can read. Sometimes the written characters are familiar, but the language is unknown. Other times, it is the reverse: the written script is unfamiliar but the language is known. Or, both script and language may be unknown.

Archaeologists and linguists known as epigraphers apply sophisticated techniques and advanced computer algorithms to ancient documents. Their decipherment work can have many resources as input, not all of which will be present in a given case: (1) monolingual inscriptions, (2) accompanying pictures or diagrams, (3) bilingual inscriptions, (4) the historical record, (5) physical artifacts, (6) bilingual dictionaries, (7) informal grammars, etc.

It is often the case that researchers have to deal with either unfamiliar script or a script unrecognized for the time being; and minimal input, i.e. sources with monolingual inscriptions or pictographic inscriptions that do not fall within the scope of any known ideographic system.

Such situation has arisen in many famous cases of decipherment—for example, in the Linear B documents from Crete which turned out to be a “non-Greek” script for writing ancient Greek and in the Mayan documents from Mesoamerica. Both of these cases lay unsolved until the latter half of the 20th century (Chad-wick, 1958; Coe, 1993). In linguistic terms, the decipherment of those cases was not really a translation, but rather text-to-speech conversion.

The problem is even harder with objects from earlier periods usually referred as pre-historic times for which the utilization of ideograms rather than phonetic characters is the most relevant assumption. The sets of pictographic signs found on artifacts from the Eneolithic/Chalcolitic era for example are usually classified as decorations. Even when there exist hypotheses for early forms of writing, up to now there has been no comprehensive system for decoding them.

The large number of artifacts excavated and analyzed has created a critical mass of assumptions and unanswered questions, and has often triggered vibrant scientific discussions.

In such environment where no relevant clues had been recognized that could serve as a link between the observations of the pictograms from the pre-historic archaeological findings and what has already been identified and deciphered on artifacts from later eras, numerous hypotheses flourish some of which well surpass the scope of scientific research.

Archaeological excavations in South-Eastern Europe and the Eastern Mediterranean continuously unearth objects inscribed with previously unknown symbols. For almost a century research communities from different countries and various backgrounds have been raising the assumption that the inscriptions on their findings are pictograms and the artifacts under analysis have been subsequently carbon-dated to before 5000BC, much earlier than the earliest recognized writing systems of the Sumerians and Minoans. To date, thousands of fragments with similar inscriptions have been found on various archaeological sites throughout South-Eastern Europe, notably in Bulgaria, Greece, FYROM, Romania, eastern Hungary, Moldova, southern Ukraine and locations in the former Yugoslavia.

Most of the inscriptions are on pottery, with the remainder appearing on whorls (flat cylindrical annuli), figurines, and a small collection of other objects. A large part of the inscriptions consist of a single symbol. The symbols themselves consist of a variety of abstract and representative pictograms, including zoomorphic (animal-like) representations, combs or brush patterns and abstract symbols such as swastikas, crosses and chevrons. Other objects include groups of symbols, of which some are arranged in no particularly obvious pattern, with the result that neither the order nor the direction of the signs in these groups was considered readily determinable. The usage of symbols varies significantly between objects: symbols that appear by themselves tend almost exclusively to appear on pots, while symbols that are grouped with other symbols tend to appear on whorls and tablets.

The importance of these findings lies in the fact that the oldest of them are dated around 5000BC, roughly fifteen hundred to two thousand years before the proto-Sumerian pictographic script from Uruk (modern Iraq), which is usually considered as the oldest known script. Analyses of the symbols showed that they had little similarity with Near Eastern writing, leading to the view that they probably arose independently of the Sumerian civilization. There are some similarities between the symbols and other Neolithic symbologies found elsewhere, as far afield as Egypt, Crete and even China. However, Chinese scholars have suggested that such signs were produced by a convergent development of what might be called a precursor to writing which evolved independently in a number of societies.

Prior to the project that triggered the invention described in the current application there was no consistent hypothesis which language used the symbols, or indeed whether they stand for a language in the first place.

A new methodology for decoding inscriptions on ancient artifacts is needed that can put the problems into a more robust and comprehensive setting and provide a vehicle for archaeological, historical and linguistic investigations compliant with the standards of scientific consistency.

### BRIEF SUMMARY OF INVENTION

The invention is a method for decoding/transcribing and reading/pictographic characters found on ancient artifacts which follows a logical scheme and a scientific hypothesis that has not been applied to date as far as the common scientific research domain is concerned. The method goes beyond the boundaries of linguistic analysis and archaeological and cryptographic research and is based on the inventor's observations and hypothesis that representatives of the ethnic groups that inhabited the lands later known as Ancient Thrace or the territories of the Thracian Diaspora used a script in the engravings they made on various artifacts which can be considered an early version of the Hieroglyphic script known from artifacts and the pyramid texts of Ancient Egypt.

The method can be applied to sets of pictograms identified on artifacts dated either prior, during, or after the time of the beginnings of Dynastic Ancient Egypt (circa 3100 BC) and comprises the following steps:

1) First, the pictogram sets are discerned and presented in schematic drawings either by highlighting or by any other means for making the pictographic signs of interest discernible and/or identifiable from the material while aiming to assure maximum consistency with the source;

2) Then, analogues for the sets of pictographic signs thus identified, are searched and found in Hieroglyphic Inscriptions, following the stylized version of the pictographic script from the pyramid texts of Ancient Egypt, independent of the calligraphic styles applied.

3) The next step is transcribing the identified above sets of pictograms (as described in step 1.), by replacing each pictogram with its Hieroglyphic analogue found in Hieroglyphic inscriptions in Ancient Egypt (as described in step 2.).

4) Thus transcribed in the form and shape of Egyptian Hieroglyphs, these characters are then translated into modern languages, using the scientifically accepted systems for reading the Egyptian hieroglyphic script.

The invention relates to a technique for transforming and/or transcribing the pictograms on any, or all of the found artifacts, as well as any yet to be found and to be dated prior to year 400 AD or the latest recorded period when the Thracian ethnicity has been mentioned, whichever turns out to be the latest historical record at the time of the latest finds, originating from all geographic areas, including but not limited to the territories historically referred to as Ancient Thrace and the Thracian Diaspora which include parts, or all of present day Bulgaria, Greece, Romania, Serbia and Montenegro, FYROM, Albania, Turkey, and other Mediterranean countries in Europe, Africa, Asia Minor, and the Near and Middle East.

Two embodiments for decoding and providing a translation of pictogram sets that have been incomprehensible to the research community prior to applying the method of the invention are disclosed herein below.

### BRIEF DESCRIPTION OF THE DRAWINGS

For a better understanding of the present invention, reference may be made to the accompanying drawings in which:

FIGS. 1A-1D represent ancient artifact 1, namely The Votive Tablet from Gradeshnitsa found in present-day Bulgaria, and dated back to approximately 5000BC. It contains 4 rows of pictographic signs visible upon the tablet's schematic drawings. They are presented in a computer-generated drawing of the artifact and of its pictograms, and in a schematic presentation of the ancient pictographic signs and then also in their subsequent transcription, using the stylized later version of the pictographic script, known to us from the pyramid texts of Ancient Egypt.

FIGS. 2A-2D and 3A-3D represent ancient artifact 2, namely The Sacred Tablet from the village of Karanovo, present Bulgaria dated back to approximately 4000BC. It contains two rows of pictographic signs, separated by a horizontal line. The signs engraved under the horizontal line are inverted (i.e. head-down) and the tablet needs to be turned 180° around to full diametrical opposition, so that the reading of the second row of text under the horizontal line be feasible.

FIGS. 2A-2D show what we refer to as Row 1 of the inscription on artifact 2, in a computer-generated drawing of the artifact and of its pictograms, and in a schematic presentation of the ancient pictographic signs and then also in their subsequent transcription, using the stylized later version of the pictographic script, known to us from the pyramid texts of Ancient Egypt.

FIGS. 3A-3D show what we refer to as Row 2 of the inscription on artifact 2, in a computer-generated drawing of the artifact and of its pictograms, and in a schematic presentation of the ancient pictographic signs, and then also in their subsequent transcription, using the stylized later version of the pictographic script, known to us from the pyramid texts of Ancient Egypt.

### DETAILED DESCRIPTION OF INVENTION

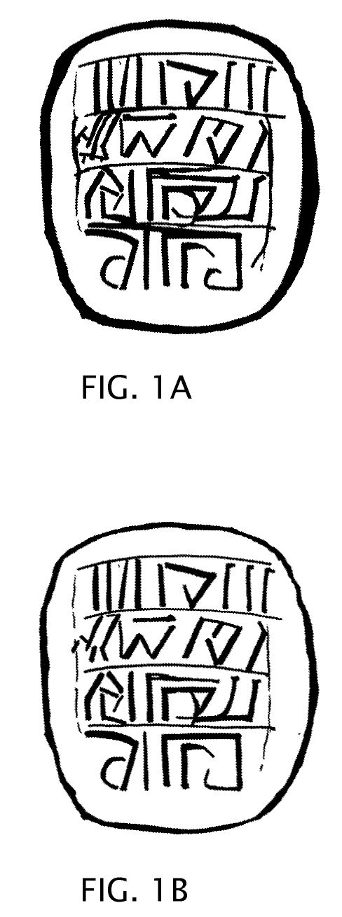

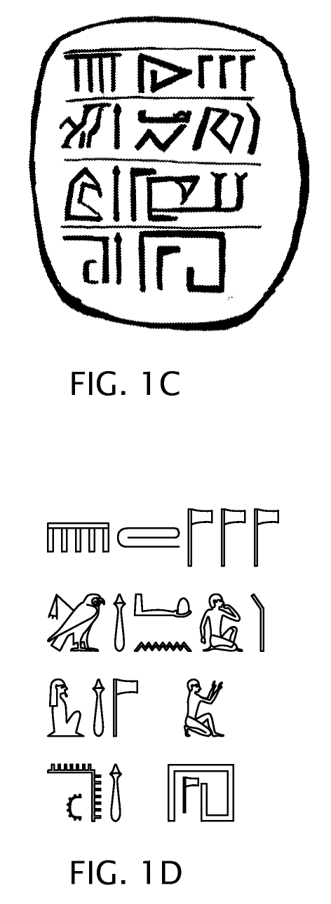

Two particular embodiments of the present invention are illustrated in FIGS. 1-3. Both embodiments make use of artifacts that have been subject to numerous research projects and have been scientifically analyzed and documented for origin and dating. Artifact 1 is currently part of the permanent exposition of the Vraca Museum of History in the city of Vraca, Bulgaria and is usually referred to as the “Gradesnica (Gradeshnitsa) Plate” or “Tablet from Gradesnica (Gradeshnitsa)” in the specialized literature. Artifact 2 is part of the permanent exposition of The National Museum of Archaeology in Sofia, Bulgaria and is usually referred to as the “Karanovo seal” or “Tablet from Karanovo” in related publications.

From the following detailed description it should be apparent that the method of the present invention is also applicable to other artifacts with discernible pictographic signs that can be represented via analogues found in hieroglyphic inscriptions, following the stylized version of the pictographic script from the pyramid texts of Ancient Egypt which can then be translated into modern languages by utilizing the scientifically accepted systems for decoding the Egyptian hieroglyphic script.

The details of the invention and various embodiments can be better understood by referring to the figures of the drawing.

FIGS. 1A-1D show the method of the present invention applied to the votive tablet from the village of Gradeshnitsa, Vraca region, present Bulgaria, excavated in late 60's of the 20-th century and dated back to approximately 5000BC, referred to as Artifact 1 in this description.

Artifact 1 contains 4 rows of pictographic signs visible upon the tablet's computer-generated drawing (FIG. 1A). Also presented are the Drawings of the Ancient Pictograms, and their Schematic Presentation in FIGS. 1B and 1C, respectively.

Thus highlighted and identified the pictographic signs look exactly like the Hieroglyphic Inscription presented in FIG. 1D, when they are transcribed using the stylized later version of the pictographic script, known from the pyramid texts of Ancient Egypt.

Upon comparison, it might be concluded that the text displayed on FIGS. 1B and 1C, and FIG. 1D is the same identical text, and that the two calligraphic styles—the early Thracian, and the late Egyptian respectively, represent one and the same identical pictographic script, which has come to us down the ages in its condition and appearance as seen on FIG. 1A.

The hieroglyphic text upon the Tablet from Gradeshnitsa as transcribed in FIG. 1D can be read in the right-to-left direction and its translation following the well-established rules for translating Egyptian hieroglyphic writing has the following or similar interpretation, verse by verse:
(1) The Three-One God (Trinity, or gods) encompasses (dwells in) Thrace;
Or:
O God, who are dwelling in the territory of Thrace;
(2) I witness to the truth, I give offerings to the great Son of God;
Or:
I promise to give offerings to the great Son of God;
(3) I glorify the Great God;
Or:
And I will praise you, O Great God;
(4) The Temple of God is a great fortress and a secret defended place;
Or:
God, who are in your temple, be my fortress and defend me (deliver me from the enemy).

If thus transcribed text has to be conveyed by the everyday language of our modern time, it would be read similar to:
(1) O Three-One God of the land of Thrace,
(2) I vow in Truth to bring you all due offerings,
O great Son of God,
(3) And only you (shall) I praise (and exalt),
O my God (for you are) great!
(4) You who are now in your temple, (I pray, hear me),
keep me safe and deliver me (from all evil)!

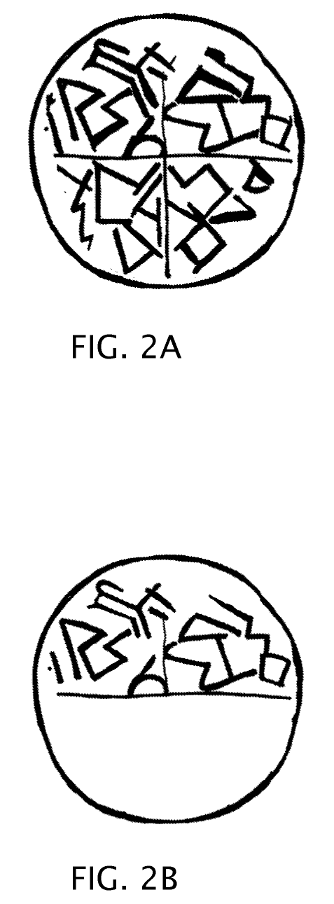

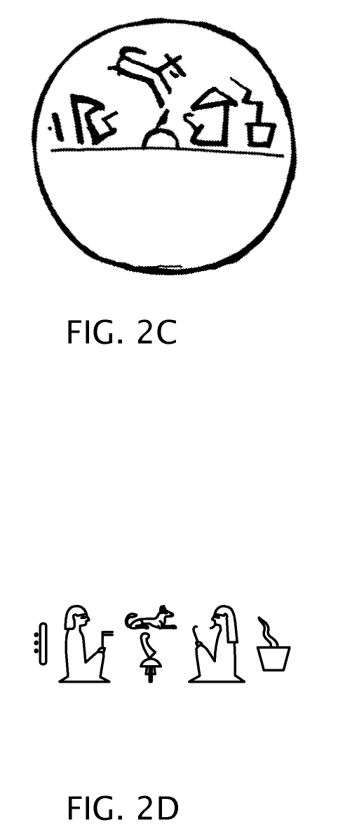

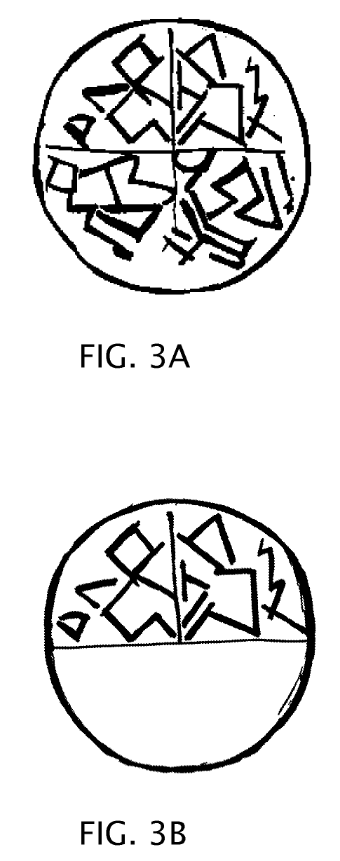

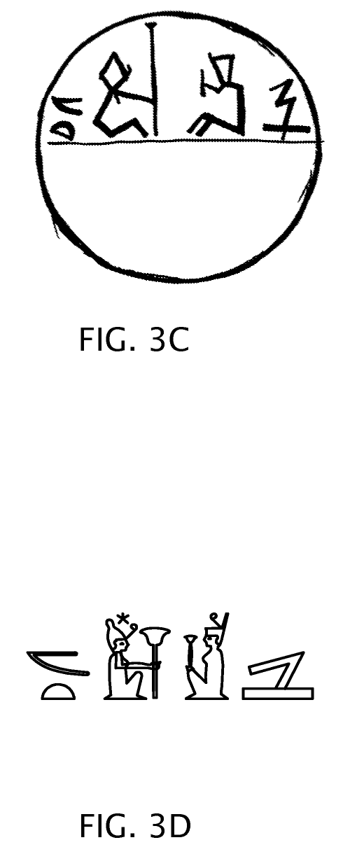

FIGS. 2A-2D and 3A-3D show the method of the present invention applied to the sacred tablet from the village of Karanovo, Nova Zagora district, present Bulgaria which is dated back to approximately 4000BC and is referred to as Artifact 2 in this description.

Artifact 2 contains two rows of pictographic signs, separated by a horizontal line with both rows visible upon the tablet's computer-generated drawings (FIGS. 2A and 3A). The same are presented in the separate drawings of the ancient pictograms (FIGS. 2B and 3B), and in their schematic presentation (FIGS. 2C and 3C), as well as in their subsequent transcriptions, using the stylized later version of the pictographic script, known to us from the pyramid texts of Ancient Egypt (FIGS. 2D and 3D).

It was found that the signs engraved under the horizontal line as seen in FIG. 2A are inverted (i.e. head-down) and the tablet needs to be turned 180° around to full diametrical opposition, so that the reading of the second row of text under the horizontal line be feasible. After the “rotation” is done, the second row of the engraved pictograms is presented in FIGS. 3A, 3B and 3C in its “corrected” upright position, for easier character recognition.

Thus highlighted and identified the pictographic signs in both row 1 and row 2 look exactly like the Hieroglyphic Inscriptions presented in FIGS. 2D and 3D, when they are transcribed, using the stylized later version of the pictographic script, known from the pyramid texts of Ancient Egypt.

Upon comparison, it is observed that each row of the text as presented in FIGS. 2B, 2C and 2D for row 1, and FIGS. 3B, 3C and 3D for row 2 is the same identical text, and that the two calligraphic styles (respectively—the early—Thracian, and the late-Egyptian), represent one and the same identical pictographic script, which has come to us down the ages, in its condition and appearance as seen on FIGS. 2A and 3A.

The hieroglyphic text upon the Tablet from Karanovo (as transcribed in FIGS. 2D and 3D) can be read either in the right-to-left, or in the left-to-right direction because of the symmetrical position of the pictograms around a central axis. Its translation following the well-established rules for translating Egyptian hieroglyphic writing has the following or similar interpretation, verse by verse:

(Row 1) The earthly human realm is separated by the Grave and the Guardian (of the Resurrection) between the Living and the Dead, from the fiery divine realm;

Or:

Through (the mystery) of Death and Resurrection, the earthly human becomes a divine being;

(Row 2) Falsehood (Lie, Injustice) reigns in the lower (earthly) realm, while Truth (Justice) reigns supreme in the upper (divine) realm;

Or:

The one who has been initiated, has exchanged his Crown of the Lower Realm, for the High Crown of the Upper Realm, and has passed from Falsehood into the Truth, ruling with the high Priestly Scepter (of Truth and Justice) now firmly in his hand.

If thus transcribed text has to be conveyed by the everyday language of our modern time, it would be read similar to:

(Row 1) Whosoever has been initiated in the Mystery of Death and Resurrection, he has been born anew and his new nature is Divine.

(Row 2) He has left all Falsehood and has come to know The Truth. He now reigns injustice and Truth, with the Scepter and Crown of the Upper Realm, being the Ruler of both (the Upper and Lower) worlds.

From a technical linguistic point of view, it is worth noting here, that the texts transcribed from both Artifacts 1 and 2 do not give us adequate clues as to the phonetic pronunciation of the ancient words written in it, or any information about the exact phonetic, or grammatical nature of the ancient language, for that matter. Almost all of the hieroglyphic signs engraved on both artifacts are only ideograms in nature even in the hieroglyphic script of Ancient Egypt as far as the scientific community interprets it for the time being, and therefore, the pronunciation of the pictograms could be identical to, similar to (as in similar neighboring dialects), or entirely dissimilar (different) from that of the Ancient Egyptian speech.

The two decoding examples shown above illustrate a novel method for transcribing and decoding/reading sets of pictographic characters found on ancient artifacts. A user of the present invention may choose any similar decoding embodiment, or an equivalent thereof, depending upon the artifact(s) under analysis. In this regard, it is recognized that various forms of the subject ancient scripts decoding and translation could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

What is claimed is:

1. A new method for decoding/reading and translating of ancient pictographic characters found on ancient artifacts comprising the following steps:
(a) pinpointing sets of ancient pictograms upon the ancient artifacts;
(b) presenting the sets of ancient pictographic signs discerned in identifiable schematic drawings;
(c) searching and finding the corresponding analogues to the above identified sets of ancient pictographic signs, as these analogues existed in Egyptian Hieroglyphic Inscriptions,
(d) transcribing the ancient pictograms as identified in step (b) by replacing them with their analogous hieroglyphic signs, using their stylized version as found in step (c), independent of the calligraphic styles applied; and
(e) translating the sets of characters thus transcribed in the form and shape of Egyptian Hieroglyphs, into modern languages, using the scientifically accepted systems for reading the Egyptian hieroglyphic script.

2. The method as recited in claim 1 wherein the sets of pictographic characters comprise the pictograms on any, or all of the found artifacts, as well as any yet to be found which are or will be dated prior to year 400 AD or the latest recorded period when the Thracian ethnicity has been mentioned, whichever turns out to be the latest historical record at the time of the latest finds, originating from all geographic areas, including but not limited to the territories historically referred to as Ancient Thrace and the Thracian Diaspora which to the current knowledge include parts, or all of present day Bulgaria, Greece, Romania, Serbia and Montenegro, FYROM, Albania, Turkey, and other Mediterranean countries in Europe, Africa, Asia Minor, and the Near and Middle East.
